(19) United States
(12) Patent Application Publication
(10) Pub. No.: US 2025/0007350 A1
(43) Pub. Date: Jan. 2, 2025

(54) ELECTRIC MOTOR, METHOD FOR PRODUCING A HOUSING FOR AN ELECTRIC MOTOR, AND WATER SPORT DEVICE COMPRISING AN ELECTRIC MOTOR

(71) Applicant: WBV WEISENBURGER BAU+VERWALTUNG GMBH, Karlsruhe (DE)

(72) Inventor: Frankowiak TIMO, Gernsbach (DE)

(73) Assignee: WBV WEISENBURGER BAU+VERWALTUNG GMBH, Karlsruhe (DE)

(21) Appl. No.: 18/712,983

(22) PCT Filed: Mar. 10, 2023
(86) PCT No.: PCT/EP2023/056128

§ 371 Date: May 23, 2024

(30) Foreign Application Priority Data
Apr. 7, 2022 (DE) 10 2022 108 371.3

(51) Int. Cl. H02K 5/20; B63B 32/10; H02K 9/193; H02K 15/14

(52) U.S. Cl. CPC H02K 5/203; H02K 9/193; H02K 15/14; B63B 32/10; H02K 2211/03

(57) ABSTRACT

The invention relates to an electric motor with a housing (800) with a shaft (604) aligned in the direction of a longitudinal axis (L) and with an inner wall (801) and an outer wall (802) arranged around it, between which at least a section of a coolant channel (601) for a coolant flow runs, and with a rotor (606) arranged in the interior of the housing (800) and a stator (607), wherein ribs (803) aligned in the direction of the longitudinal axis (L) are arranged between the inner wall (801) and the outer wall (802), which ribs form lateral walls of the section of the coolant channel (601), and at least one rib (803) has a breakthrough (804) which permits the coolant flow from one side of the at least one rib (803) to another side of the at least one rib (803).

The invention relates to an electric motor according to the general term of claim 1 and to a method for manufacturing a housing for the electric motor as well as a water sports device with the electric motor.

Water sports equipment in the form of surfboards is of course known in the prior art. For example, DE 10 2015 103 503.0 discloses a surfboard with an electric motor.

Cooling systems are known in the prior art to increase the performance of electric motors with a controller. In CN 205738032 U, water is diverted from the water flow of a jet drive and used to cool the controller. However, the cooling system is not suitable for cooling the windings of the electric motor.

It is the object of the present invention to provide an electric motor that is particularly powerful and yet can be manufactured at low cost.

In a second aspect, it is the object of the present invention to provide a method for manufacturing the electric motor.

In a third aspect, it is the object of the present invention to provide a water sports device with such an electric motor.

In its first aspect, the object is fulfilled by an electric motor mentioned at the beginning with the features of claim 1.

The electric motor according to the invention comprises a housing with a shaft aligned in the direction of a longitudinal axis and with a preferably cylindrical inner wall and an outer wall preferably arranged concentrically around the inner wall and at least one section of a coolant channel extending between the inner wall and the outer wall for a coolant flow and with a rotor arranged inside the housing, which is preferably connected to the shaft in a rotationally fixed manner, and a stator, which is preferably connected to the housing in a rotationally fixed manner. According to the invention, ribs are arranged between the inner wall and the outer wall in the direction of the longitudinal axis, preferably parallel to the longitudinal axis, which also form the cooling channel. Preferably, the ribs delimit the section of the cooling channel laterally along the circumference of the housing, while the cooling channel is delimited radially outwards by the outer wall and radially inwards by the inner wall, and at least one rib has an breakthrough which permits the flow of coolant from one side of one rib to another side of one rib.

A rib is understood here to be a shape which, in a longitudinal direction which preferably coincides with the longitudinal axis of the electric motor, has an extent which is several times greater, in particular 10 to 50 times greater, than an extent along a width which preferably coincides with an extent in the circumferential direction of the housing and a height which preferably coincides with an extent along the radial extent of the housing. The ribs are preferably straight and preferably run parallel to each other. However, embodiments are also conceivable in which the ribs are curved and nevertheless preferably have a constant spacing from one another along the longitudinal extension. The ribs preferably have a constant cross-section along their length, which is quadrangular, preferably square, each with an outer and an inner edge curvature that is adapted to a curvature of the inner wall and outer wall.

A wall is understood here to be a shape with a significantly smaller height compared to its length and width, which preferably coincides with the circumference of the housing. The height of the wall is preferably between 1/10 and 1/50 of its length and/or width. The wall preferably has a constant height along its extent, apart from areas in which it comes into contact with the ribs.

Preferably, the coolant flow runs along one side of one rib, preferably each rib, in the direction of the longitudinal axis and along the other side of one rib, preferably each rib, against the direction of the longitudinal axis or vice versa.

The arrangement of ribs aligned in the direction of the longitudinal axis between the inner and outer walls in accordance with the invention, which preferably extend over the entire height between the inner and outer walls, forms chambers along the circumference between the ribs, which are connected to one another in a coolant-conducting manner by means of openings moulded into the ribs and thus together form a section of a coolant channel for a coolant flow. The boundaries of a chamber are formed by one rib and a neighbouring rib and the inner wall and the outer wall. The chambers have an annular segment shape in cross-section.

Preferably, coolant flows through almost the entire housing. The coolant preferably runs through the entire space, except for the ribs, between the inner and outer walls, so that the rotor and stator arranged inside the housing, which generate heat during operation, can be cooled particularly effectively. The housing is preferably made of aluminium or steel, which are particularly good heat conductors.

Preferably, the section of the coolant channel meanders along a circumferential direction of the housing. The section of the coolant channel preferably encircles the housing completely.

In a preferred embodiment of the invention, the housing is closed at one end on the side facing the shaft with a bearing cover on the side facing the shaft, through which a coolant inlet and a coolant outlet are guided, which are connected to the section of the coolant channel in a coolant-conducting manner. Favourably, the coolant inlet and coolant outlet establish the connection to the externally supplied coolant in order to enable heat dissipation. The coolant inlet is preferably connected to a coolant source via a coolant hose and the coolant outlet is preferably connected to a coolant sink via a coolant hose. The coolant entering the section of the cooling channel via the coolant inlet absorbs the heat produced by the electric motor during operation and transports it away via the coolant outlet. The coolant system can be open, but it can also be a coolant circuit.

Particularly preferably, the housing is closed at one end on the side facing away from the shaft with a bearing cover on the side facing away from the shaft, which preferably has a coolant inlet into a bypass and a coolant outlet from a bypass. The bypass can be a further section of the coolant channel. The section of the coolant channel that runs in the housing and the further section of the coolant channel formed by the bypass together form the coolant channel of the electric motor, which is preferably connected to a coolant supply from and a coolant discharge to the outside via the coolant inlet and outlet.

In a further preferred embodiment of the invention, the electric motor has a cooling plate which is arranged on the outside of the housing directly on the bearing cover on the side facing away from the shaft and between which the bypass is moulded. The bypass can be moulded exclusively into the bearing cover on the side facing away from the shaft or exclusively into the cooling plate or into both components. The further design of the electric motor according to the invention makes use of the idea of leading the section of the coolant channel which is located in the housing out of the housing and forming a further section of the coolant channel by means of a bypass which is arranged between a cooling plate and a bearing cover on the side facing away from the shaft, the cooling plate preferably being attached to the outside of the bearing cover as a separate component. The cooling plate and the bearing cover are screwed or clamped together and connected to each other in a coolant-tight manner by means of a groove, preferably milled into the outside of the bearing cover on the side facing away from the shaft, into which a seal is inserted. The cooling plate and the bearing cover can also be connected to each other in other ways, for example both can be glued together. In this embodiment, an additional seal can be dispensed with if necessary.

Preferably, the inner wall and outer wall are also connected to the bearing cover in a coolant-tight manner, so that the entire coolant flow along the cooling channel in the housing and through the bypass is coolant-tight and thus the interior of the housing is sealed against the coolant and the controller, along which the bypass runs, is also protected from the coolant of the bypass in a coolant-tight manner.

Preferably, the electric motor has a controller and the bypass runs along the controller. As a result, the heat generated in the controller during operation is removed by the coolant flowing through the bypass.

Particularly preferably, the controller can have a printed circuit board with MOSFETs arranged on the side facing the housing, which are in direct contact with an outer side of the cooling plate. In the case of controllers, the main heat-generating components are the MOSFETs, which are arranged somewhat separately from the other electrical components of the controller on the opposite side of the circuit board and which can be in direct contact with the cooling plate so that the heat generated there can be dissipated particularly well via the coolant circuit.

An axial shaft bearing is particularly preferably arranged in the bearing cover on the side facing the shaft.

The axial shaft bearing is designed to guide the axial load generated by an impeller, for example, through the housing into a water sports device, for example, so that the thrust is not passed through the electric motor itself but is dissipated externally via the housing.

In a preferred further development of the invention, the bearing cover on the side facing the shaft has eyelets on the shaft side radially on the outside and the bearing cover on the side facing away from the shaft has eyelets on the side facing away from the shaft radially on the outside, and the outer wall has tubular loops radially on the outside, and retaining means are inserted through the eyelets into open ends of the tubular loops. Preferably, the open ends have internal threads and the retaining means are designed as screws screwed into the internal threads.

Furthermore, the windings of the stator are advantageously arranged directly next to the inner wall, so that the heat generated in the electric motor itself can be dissipated particularly well.

The object is fulfilled in its second aspect by a method for manufacturing a housing of an electric motor with the features of claim 13.

The method according to the invention is particularly suitable for manufacturing a housing for one of the electric motors described above. Conversely, the electric motors described above advantageously have a housing produced by the method according to the invention.

According to the invention, a section is cut to length from a continuous moulded part in the length of the housing. The cut-to-length sections have an inner wall and an outer wall, between which ribs aligned in the direction of a longitudinal axis are arranged. At least one of the ribs is shortened by at least one opening at an end leading or trailing in the direction of the longitudinal axis.

The process is suitable for the cost-effective production of large quantities of housings.

Particularly preferably, the at least one rib is shortened at the leading end by the at least one breakthrough, and a neighbouring rib is shortened at the trailing end by a neighbouring breakthrough.

The various openings can have the same length or different lengths.

Preferably, tubular loops are arranged on the outside of the outer wall in the direction of the longitudinal axis and, after the sections have been cut to length, internal threads are inserted into the open ends of the tubular loops. Screws can be screwed into the internal threads, which are inserted through eyelets arranged radially on the outside of the bearing covers in order to fix the bearing covers to the housing.

Preferably, the continuous moulded part is produced using an extrusion process. Suitable material, such as aluminium, is softened and pressed through a matrix.

The object is fulfilled in its third aspect by a water sports device with the features of claim 17.

The water sports equipment is preferably a surfboard, but it can also be another type of water sports equipment.

The water sports equipment comprises one of the above-mentioned electric motors. It has a water jet drive with the impeller, which is driven by the shaft driven by the electric motor. The above-described electric motor according to the invention is particularly suitable for connection to a cooling system of the water sports device via the coolant inlet and the coolant outlet of the electric motor.

Preferably, the water jet drive comprises a jet drive with a jet tube, and a cooling water inlet for a portion of the water flowing through the jet tube is provided on the water-carrying inner side of the jet tube, which is connected to the coolant inlet of the electric motor in a water-conducting manner. The cooling water inlet of the jet pipe is preferably arranged in an area in which the water flowing through the jet pipe is at high pressure and is forced by itself through the cooling water inlet into preferably a water hose, which then flows into the cooling water inlet of the electric motor.

Favourably, the electric motor is connected to a battery in a current-conducting manner. The battery is preferably a rechargeable battery, which is provided in a watertight manner in a battery module, which is preferably arranged in the surfboard in a replaceable manner.

The housing and cooling plate are particularly preferably sealed together in a watertight manner so that the cooling water cannot enter the interior of the electric motor or the controller and also cannot enter a space surrounding the electric motor and the controller.

The invention is described by means of an embodiment example in eight figures. They show:

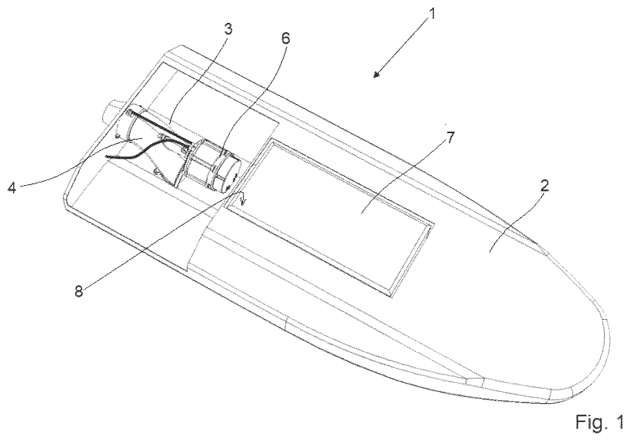

FIG. 1 A perspective view, partly as a see-through view, of a surfboard with a built-in electric motor according to the invention,

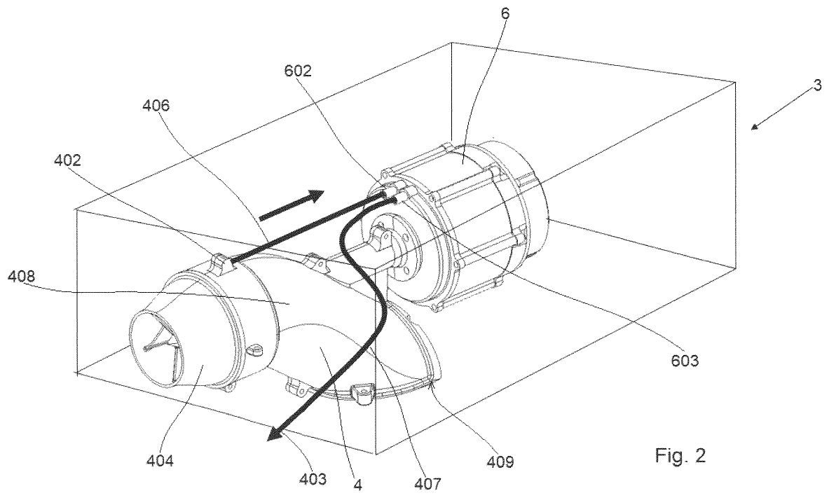

FIG. 2 a view of a drive unit of the surfboard in FIG. 1,

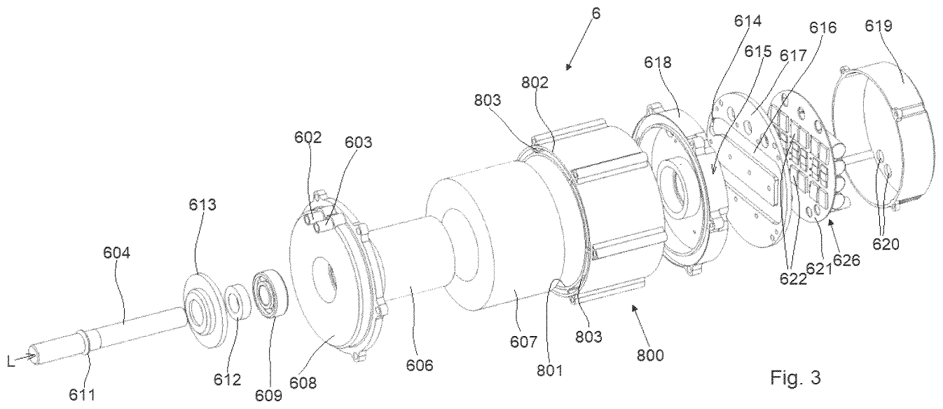

FIG. 3 an exploded diagram of the electric motor according to the invention,

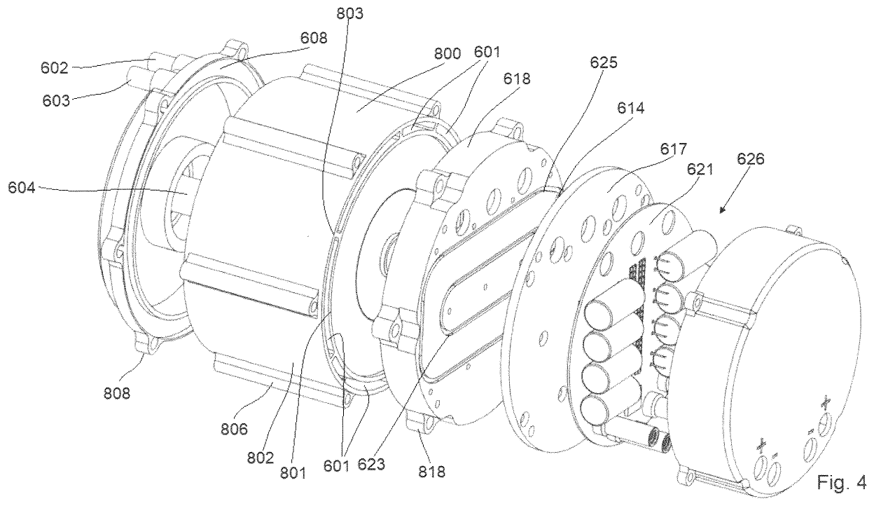

FIG. 4 a rear view of the exploded diagram of the electric motor according to the invention,

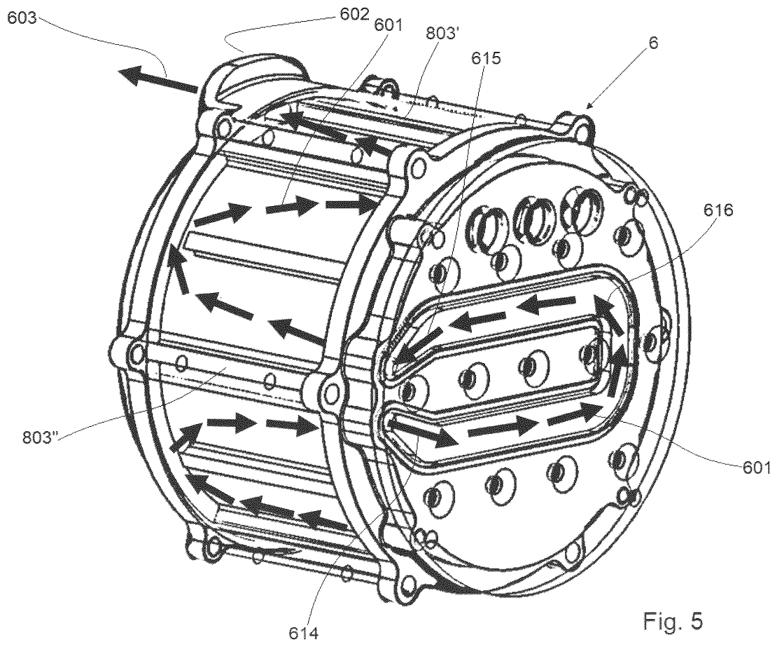

FIG. 5 the electric motor with the cooling water flow marked, partly as a transparent view,

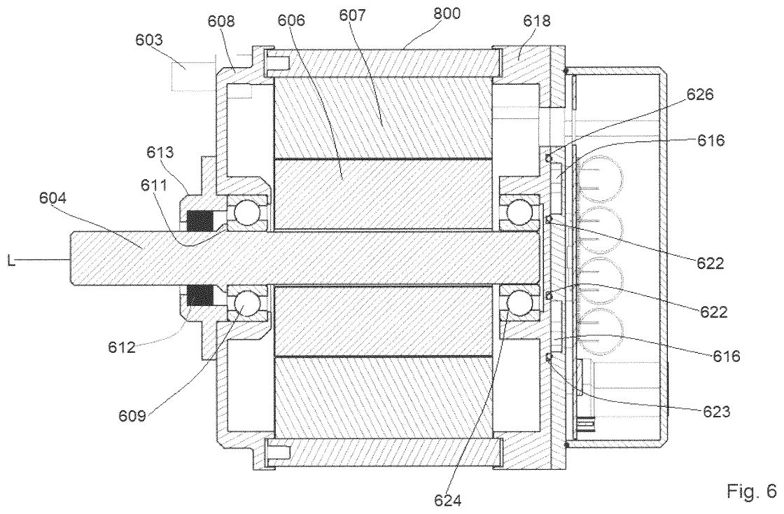

FIG. 6 a sectional view of the electric motor,

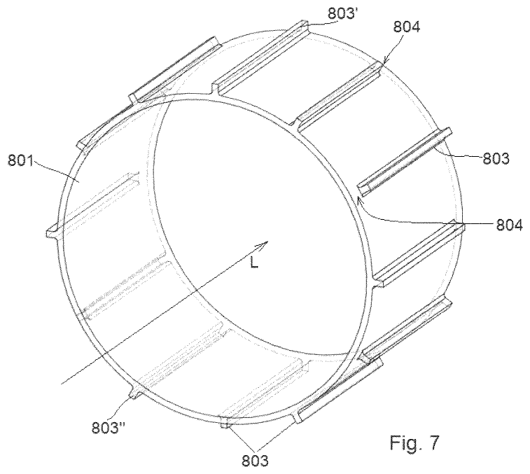

FIG. 7 an inner wall of a housing with ribs,

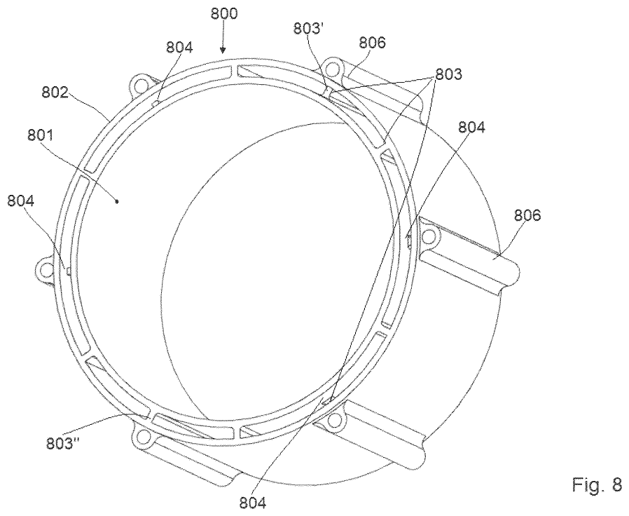

FIG. 8 the housing of the electric motor.

FIG. 1 shows a surfboard 1 with a hull component 2 in which a drive component 3 with a jet drive 4 and an electric motor 6 according to the invention is installed, as well as a battery module 7, which is interchangeably inserted in a recess 8 in the hull component 2 on the tread surface side. In principle, of course, other installation situations for the electric motor 6 according to the invention are also conceivable.

According to FIG. 2, the electric motor 6 according to the invention has a cooling water inlet 602 and a cooling water outlet 603. The cooling water inlet 602 on the electric motor 6 is connected to a cooling water inlet 402 arranged in front of a nozzle 404 in the direction of a water flow in the jet drive 4. The connection between the cooling water inlet 402 of the nozzle 404 and the cooling water inlet 602 of the electric motor 6 is made via a first hose 406. In a circumferential direction next to the cooling water inlet 602 of the electric motor 6, the cooling water outlet 603 of the electric motor 6 is provided, which is connected via a second hose 407 to a cooling water outlet 403 at the rear end of the surfboard 1 in such a way that it conducts cooling water. In principle, other connection points for the hoses on the jet drive 4 are also conceivable.

FIG. 2 shows the first hose 406 and the second hose 407 in a detailed view of the schematically depicted drive component 3, which can be inserted into the surfboard 1 in FIG. 1, preferably detachably by means of screws.

The jet drive 4 has a jet tube 408, at the bottom open end 409 of which water is sucked in and expelled via the nozzle 404 at the rear end of the surfboard 1. The recoil takes place via an impeller, not shown, which is arranged in front of the nozzle 404 in the jet tube 408 in the direction of the water flow and is driven via a shaft 604, which is guided through a wall of the jet tube 408 on the inside of the surfboard and is driven by the electric motor 6.

FIG. 3 shows an exploded view of the electric motor 6 according to the invention. The shaft 604 is shown shortened at the jet drive end. The jet drive end of the shaft 604 projects into the jet tube 408, and the impeller is mounted at its outermost end, the left-hand end in FIG. 3.

The electric motor 6 as shown in FIG. 3 and FIG. 6 comprises a rotor 606 and a stator 607. The rotor 606 is connected to the shaft 604 so that it cannot rotate. The stator 607 is non-rotatably connected to a housing 800, which is also a component of the electric motor 6. The shaft 604 is mounted on a bearing cover on the side facing the shaft 608 via a ball bearing on the side facing the shaft 609, the outer ring of which is non-rotatably arranged in the bearing cover on the side facing the shaft 608, while an inner ring of the ball bearing 609 is non-rotatably connected to the shaft 604. The shaft 604 has a circumferential projection 611, which rests on the inner ring of the ball bearing 609. The shaft 604 is sealed against the bearing cover 608 on the side facing the shaft by means of a seal 612 and a sealing sleeve 613. A bearing on the side facing the shaft of the shaft is designed as an axial bearing, so that axial loads acting through a longitudinal axis L of the shaft 604 are absorbed directly by the bearing cover on the side facing the shaft 608 and are not passed internally through the electric motor 6.

According to FIG. 3 and FIG. 4, the electric motor 6 comprises the housing 800 with an inner wall 801 and an outer wall 802 and ribs 803. The housing 800 is manufactured with the inner wall 801 and the outer wall 802 and with the initially continuous ribs 803 and tubular loops 806 arranged on the outside of the outer wall 802, preferably as an endless moulded part in an extrusion process. Sections of the continuous moulded part are successively cut to the length of the housing. Breakthroughs 804 are then inserted at the leading or trailing ends of some ribs 803. This can be done by milling, for example. By ends is meant here the outermost end, which is preferably completely removed. Internal threads are milled into open ends of the tubular loops 806. The tubular loops 806 run parallel to each other in the direction of the longitudinal axis L.

The inner wall 801 with the ribs 803 already shortened by the breakthroughs 804 is shown separately in FIG. 7. The breakthroughs 804 have the same lengths in FIG. 7.

The inner wall 801, on which the ribs 803 run radially on the outside parallel to the longitudinal axis L, is cylindrical in shape. Ribs 803 arranged directly next to each other are offset from each other by the length of a breakthrough 804. The outer wall 802, which is spaced from the inner wall 801 by a height of the ribs 803, is arranged concentrically around the inner wall 801.

As FIG. 8 shows, the ribs 803 in the housing 800 thus have the breakthroughs 804, which are arranged at the front end on the side facing the shaft or at the rear end on the side facing away from the shaft of the respective rib 803. As a rule, the breakthroughs 804 alternate along the circumference of the housing 800 at the end on the side facing the shaft and at the end on the side facing away from the shaft. A rib 803′, which separates the cooling water inlet 602 and cooling water outlet 603 for the cooling water from the jet drive 4, and a rib 803″, which separates a bypass inlet 614 from a bypass outlet 615 of the cooling water into or out of an approximately U-shaped bypass 616 of a cooling plate 617, are formed continuously in the direction of the longitudinal axis L along the housing 800, i.e. do not have a breakthrough 804.

FIG. 8 shows the housing 800 with the inner wall 801 and the outer wall 802 as well as the ribs 803. A housing section of the cooling water channel 601 is formed between the inner and outer walls 801, 802, which, as FIG. 5 shows, meanders around the entire circumference of the housing 800. The housing 800 is formed in one piece here.

According to FIG. 3, a bearing cover on the side facing away from the shaft 618 is provided on the housing on the side facing away from the shaft 800, and the cooling plate 617 is mounted directly on the side facing away from the shaft of the bearing cover on the side facing away from the shaft 618. The bypass 616 of the coolant channel 601 runs in the cooling plate 617.

A controller 626 is arranged on the outside of the cooling plate 617, which is covered in a protective manner by a controller cover 619. The controller cover 619 has two or four or another number of openings 620 for electrical contacts for electrical connection to the battery module 7. The controller 626 has a circuit board 621, on the housing side of which the MOSFETs 622, which generate a particularly large amount of heat, are arranged, which rest directly on an outer side of the cooling plate 617 and can thus be cooled particularly effectively by the coolant flow passing through the bypass 616.

FIG. 4 shows a rear view of the explosion arrangement of FIG. 3. A groove loop 625 is provided on the outside of the bearing cover on the side facing away from the shaft 618, which assumes an outer shape of the bypass 616 and seals the bearing cover 618 against the cooling plate 617. Mirroring this, the bypass 616 is fitted on the inside of the cooling plate 617. FIG. 6 shows that a sealing element 623 is inserted into the groove loop 625, which runs along the entire length of the groove loop 625. The bypass 616 brings the bypass inlet 614 into the bypass 616 and out of the housing 800 and the bypass outlet 615 out of the bypass 616 and into the housing 800. The bypass inlet 614 and the bypass outlet 615 are formed as two openings at the ends of the bypass 616, which are in direct water-conducting connection with the housing 800. One of the continuous ribs 803″ of the housing 800 is provided between the bypass inlet 614 from the housing 800 and the bypass outlet 615 into the housing 800, which directs the entire cooling water flow flowing through the housing section from the housing 800 into the bypass 616.

The coolant flow is shown in FIG. 5. The cooling water flows from the jet drive 4 into the cooling water inlet 602 of the housing 800 and runs along the rear of the housing 800 in a meandering pattern in each loop along the entire longitudinal extent of the housing 800 up to the front side of the housing 800 shown in FIG. 5, from where the coolant flow branches off completely into the bypass 616, flows through the bypass 616 and from there flows back into the housing 800. The cooling water channel 601 is formed by the bypass 616 and the housing section of the cooling channel. The cooling water channel 601 according to the invention thus permits cooling of the stator 607 on the one hand and cooling of the controller 626 via the bypass 616 on the other hand, in particular cooling of the MOSFETs 622 resting directly on the cooling plate 617.

FIG. 6 shows a sectional view of the electric motor 6. The shaft 604 is mounted in the ball bearing on the side facing the shaft 609 and a ball bearing on the side facing away from the shaft 624. The ball bearing on the side facing the shaft 609 is designed as an axial bearing, which absorbs the axial load of the shaft 604 and transfers it via the bearing cover on the side facing the shaft 608 into a propulsion of the surfboard 1. The ball bearing on the side facing away from the shaft 624 is arranged in the bearing cover on the side facing away from the shaft 618.

The housing 800 shown in FIGS. 7 and 8 can be manufactured in series at low cost by using an extrusion process to press a suitable metal through a mould which forms a cross-section of the housing 800 in a complementary manner. An continuous moulded part is formed with the outer wall 802, the inner wall 801, the continuous ribs 803 and the tubular loops 806 arranged on the outside of the outer wall 802. After solidification of the extruded component, sections are cut to length from the continous moulded part to the length of the housing. Internal threads are milled into the open ends of the tubular loops 806, and the breakthroughs 804 are milled from the ends of the initially continuous ribs 803.

The bearing cover on the side facing the shaft 608 has radially outer moulded eyelets on the side facing the shaft 808 and the bearing cover on the side facing away from the shaft 618 has radially outer arranged eyelets on the side facing away from the shaft 818. Screws are guided through the eyelets 808, 818, which are screwed into tubular loops 806 arranged on the outside of the outer wall 802 of the housing 800. The tubular loops 806 each have an internal thread at their end for this purpose.

### LIST OF REFERENCE SYMBOLS

1 Surfboard
2 Hull component
3 Drive component
4 Jet drive
6 Electric motor
7 Battery module
8 Recess
402 Cooling water inlet
403 Cooling water outlet
404 Nozzle
406 First hose
407 Second hose
408 Jet tube
409 Bottom open end
601 Cooling water channel
602 Cooling water inlet
603 Cooling water outlet
604 Shaft
606 Rotor
607 Stator
608 Bearing cover on the side facing the shaft
609 Ball bearing on the side facing the shaft
611 Circumferential projection
612 Seal
613 Sealing sleeve
614 Bypass inlet
615 Bypass outlet
616 Bypass
617 Cooling plate
618 Bearing cover on the side facing away from the shaft
619 Controller cover
620 Openings
621 Circuit board
622 MOSFETs
623 Sealing element
624 Ball bearing on the side facing away from the shaft
625 Groove loop
626 Controller
800 Housing
801 Inner wall
802 Outer wall
803 Ribs
803′ Continuous rib
803″ Continuous rib
804 Breakthroughs
806 Tubular loop
808 Eyelet on the side facing the shaft
818 Eyelet on the side facing away from the shaft
L Longitudinal axis

1. Electric motor with a housing (800) with a shaft (604) aligned in the direction of a longitudinal axis (L) and with an inner wall (801) and an outer wall (802) arranged around it, between which at least a section of a coolant channel (601) for a coolant flow runs, and with a rotor (606) arranged in the interior of the housing (800) and a stator (607),
characterised in that ribs (803) aligned in the direction of the longitudinal axis (L) are arranged between the inner wall (801) and the outer wall (802), which form lateral walls of the section of the coolant water channel (601), and at least one rib (803) has an breakthrough (804) which permits the coolant flow from one side of the at least one rib (803) to another side of the at least one rib (803).

2. Electric motor according to claim 1,
characterised in that the section of the cooling channel (601) extends along adjacent ribs (803) and through the breakthroughs (804).

3. Electric motor according to claim 1,
characterised in that the at least one rib (803) has the breakthrough (804) at a front end in the direction of the longitudinal axis (L) and an adjacent rib (803) has an adjacent breakthrough (804) at a rear end in the direction of the longitudinal axis (L).

4. Electric motor according to claim 1,
characterised in that the section of the cooling channel (601) meanders along a circumferential direction of the housing (800).

5. Electric motor according to claim 1,
characterised in that the housing (800) is closed at an end on the side facing the shaft with a bearing cover on the side facing the shaft (608), through which a coolant inlet (602) and a coolant outlet (603) are guided, which are connected to the section of the coolant channel (601) in a coolant-conducting manner.

6. Electric motor according to claim 1,
characterised in that the housing (800) is closed at the end on the side facing away from the shaft by an bearing cover on the side facing away from the shaft (618), which has a coolant inlet (614) into and a coolant outlet (615) out of a bypass (616).

7. Electric motor according to claim 1,
characterised by a cooling plate (617), which is arranged on the outside of the housing directly on the bearing cover on the side facing away from the shaft (618), and characterised in that the bypass (616) is formed between the cooling plate (617) and the bearing cover (618) on the side facing away from the shaft.

8. Electric motor according to claim 1,
characterised by a controller (626) and in that the bypass (616) runs along the controller (626).

9. Electric motor according to claim 8,
characterised in that the controller (626) has a circuit board, on the side of which facing the housing (800) MOSFETS (622) are arranged, which bear directly on an outer side of the cooling plate (617).

10. Electric motor according to claim 1,
characterised by an axial shaft bearing in the bearing cover on the side facing the shaft (608).

11. Electric motor according to claim 1,
characterised in that the bearing cover on the side facing the shaft (608) has eyelets on the side facing the shaft (808) radially on the outside and the bearing cover on the side facing away from the shaft (618) has eyelets on the side facing away from the shaft (818) radially on the outside and the outer wall (802) has tubular loops (806) radially on the outside and retaining means are inserted through the eyelets into open ends of the tubular loops (806).

12. Electric motor according to claim 1,
characterised in that windings of the stator (607) are arranged next to the inner wall (801).

13. Method of manufacturing a housing (800) for an electric motor (6), in that sections of a housing length are cut to length from an continuous moulded part in the direction of a longitudinal axis (L) and the cut-to-length sections have an inner wall (801) and an outer wall (802), between which ribs (803) aligned in the direction of the longitudinal axis (L) are arranged, and at least one of the ribs (803) is shortened by at least one breakthrough (804) at an end leading or trailing in the direction of the longitudinal axis (L).

14. Method according to claim 13,
characterised in that the at least one rib (803) at the leading end is shortened by the at least one breakthrough (804) and an adjacent rib (804) at the trailing end is shortened by an adjacent breakthrough (804).

15. Method according to claim 13,
characterised in that tubular loops (806) are arranged on the outside of the outer wall (802), aligned in the direction of the longitudinal axis (L), and internal threads are inserted into open ends of the tubular loops (806) after the sections have been cut to length.

16. Method according to claim 13, characterised in that the continuous moulded part is produced in an extrusion process.

17. Water sports device with an electric motor (6) according to claim 1,
with a water jet drive (4) with an impeller, which is driven by the shaft (604) driven by the electric motor (6).

18. Water sports device according to claim 17,
characterised in that the water jet drive comprises a jet drive (4) with a jet tube (408) and a cooling water inlet (402) for a portion of the water flowing through the jet tube (408) is provided on the jet tube (408) for the water jet of the jet drive (4), which cooling water inlet is connected to the cooling water inlet (602) of the electric motor (6) in a water-conducting manner.

19. A water sports device according to claim 17,
characterised in that the electric motor (6) is connected to a battery in a current-conducting manner.

20. Water sports device according to claim 17,
characterised in that the water sports device is an electrically powered surfboard.
